(19) United States
(12) Patent Application Publication
(10) Pub. No.: US 2026/0175839 A1
(43) Pub. Date: Jun. 25, 2026

(54) SYSTEMS AND METHODS OF CONTROLLING A VEHICLE

(71) Applicant: University of South Florida, Tampa, FL (US)

(72) Inventors: Arman Sargolzaei, Tampa, FL (US); Parisa Ansari Bonab, Tampa, FL (US)

(21) Appl. No.: 19/428,802

(22) Filed: Dec. 22, 2025

Related U.S. Application Data
(60) Provisional application No. 63/737,376, filed on Dec. 20, 2024.

(51) Int. Cl. B60W 30/14; G06N 3/092; H04L 9/40; H04W 4/46

(52) U.S. Cl. CPC B60W 30/143; G06N 3/092; H04L 63/1416; H04W 4/46; B60W 2420/408; B60W 2554/80; B60W 2556/65

(57) ABSTRACT

A method for controlling a vehicle including receiving an adaptive cruise control signal, generating, using an actor-critic reinforcement learning model, an estimation of a false data injection attack associated with the adaptive cruise control signal, generating a control signal, and controlling acceleration of the vehicle based on the control signal.

### CROSS-REFERENCE TO RELATED APPLICATIONS

This application claims the benefit of U.S. Provisional Patent Application No. 63/737,376, filed on Dec. 20, 2024, the entire contents of which are incorporated herein by reference.

### STATEMENT REGARDING FEDERALLY SPONSORED RESEARCH OR DEVELOPMENT

This invention was made with government support under ECCS-EPCN-2241718 awarded by the National Science Foundation. The government has certain rights in the invention.

### BACKGROUND

The present disclosure relates generally to the field of automated vehicles, and more specifically to an adaptive cruise control system and methods for controlling a vehicle.

### SUMMARY

In some aspects, the techniques described herein relate to a method for controlling a vehicle, including: receiving, from an external source, an adaptive cruise control signal; generating, using an actor-critic reinforcement learning model, an estimation of a false data injection attack associated with the adaptive cruise control signal; generating, based on (i) the estimation, (ii) an error describing a difference between (a) an actual distance between the vehicle and another vehicle and (b) a desired distance between the vehicle and the another vehicle, and (iii) a velocity of the vehicle and the another vehicle, a control signal; and controlling acceleration of the vehicle based on the control signal.

In some aspects, the techniques described herein relate to a method, further including generating a feedback signal based on an integral of a sign of the error, and wherein generating the control signal is further based on the feedback signal.

In some aspects, the techniques described herein relate to a method, wherein the actor-critic reinforcement learning model includes an actor implemented as a first neural network and a critic implemented as a second neural network.

In some aspects, the techniques described herein relate to a method, wherein the first neural network and the second neural network receive the feedback signal as an input.

In some aspects, the techniques described herein relate to a method, wherein generating the estimation includes: generating, using the first neural network, a reinforcement signal based on (i) the feedback signal and (ii) the error; updating the second neural network using the reinforcement signal; and generating the control signal using the updated second neural network.

In some aspects, the techniques described herein relate to a method, further including measuring, using a radar, the actual distance between the vehicle and the another vehicle.

In some aspects, the techniques described herein relate to a method, wherein controlling acceleration of the vehicle includes controlling at least one of (i) a brake of the vehicle and/or (ii) a throttle of the vehicle.

In some aspects, the techniques described herein relate to a cooperative adaptive cruise control (CACC) system for a vehicle, including: a processing circuit including a processor and memory, the memory having instructions stored thereon that, when executed by the processor, cause the processor to: receive a signal, wherein the signal is transmitted from a wireless transmitter that is not positioned on the vehicle; generate, using an actor-critic reinforcement learning model, an estimation of a false data injection attack associated with the signal; generate, based on (i) the estimation, (ii) an error describing a difference between (a) an actual distance between the vehicle and another vehicle and (b) a desired distance between the vehicle and the another vehicle, and (iii) a velocity of the vehicle and the another vehicle, a control signal; and control acceleration of the vehicle based on the control signal.

In some aspects, the techniques described herein relate to a CACC system, wherein the instructions further cause the processor to generate a feedback signal based on an integral of a sign of the error, and wherein generating the control signal is further based on the feedback signal.

In some aspects, the techniques described herein relate to a CACC system, wherein the actor-critic reinforcement learning model includes an actor implemented as a first neural network and a critic implemented as a second neural network.

In some aspects, the techniques described herein relate to a CACC system, wherein the first neural network and the second neural network receive the feedback signal as an input.

In some aspects, the techniques described herein relate to a CACC system, wherein generating the estimation includes: generating, using the first neural network, a reinforcement signal based on (i) the feedback signal and (ii) the error; updating the second neural network using the reinforcement signal; and generating the control signal using the updated second neural network.

In some aspects, the techniques described herein relate to a CACC system, further including a radar, and wherein the instructions further cause the processor to determine the actual distance between the vehicle and the another vehicle based on at least one measurement from the radar.

In some aspects, the techniques described herein relate to a CACC system, wherein controlling acceleration of the vehicle includes controlling at least one of (i) a brake of the vehicle and/or (ii) a throttle of the vehicle.

In some aspects, the techniques described herein relate to a vehicle, including: an antenna configured to receive at least a signal transmitted from a wireless transmitter that is not positioned on the vehicle; a throttle; a brake; and an adaptive cruise control system configured to: determine an error describing a difference between (a) an actual distance between the vehicle and another vehicle and (b) a desired distance between the vehicle and the another vehicle; generate, using an actor-critic reinforcement learning model based on the error, an estimation of a false data injection attack associated with the signal; generate, based on (i) the estimation, (ii) the error, and (iii) a velocity of the vehicle and the another vehicle, a control signal; and operate at least one of the throttle and/or the brake based on the control signal.

In some aspects, the techniques described herein relate to a vehicle, wherein the adaptive cruise control system is further configured to generate a feedback signal based on an integral of a sign of the error, and wherein generating the control signal is further based on the feedback signal.

In some aspects, the techniques described herein relate to a vehicle, wherein the actor-critic reinforcement learning model includes an actor implemented as a first neural network and a critic implemented as a second neural network.

In some aspects, the techniques described herein relate to a vehicle, wherein the first neural network and the second neural network receive the feedback signal as an input.

In some aspects, the techniques described herein relate to a vehicle, wherein generating the estimation includes: generating, using the first neural network, a reinforcement signal based on (i) the feedback signal and (ii) the error; updating the second neural network using the reinforcement signal; and generating the control signal using the updated second neural network.

In some aspects, the techniques described herein relate to a vehicle, further including a radar, and wherein the adaptive cruise control system is further configured to measure the actual distance between the vehicle and the another vehicle using the radar . . .

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 is a block diagram of a vehicle having an adaptive cruise control system (e.g., a cooperative adaptive cruise control system), according to an exemplary embodiment.

FIG. 2 is a flow diagram illustrating a method of controlling a vehicle, according to an exemplary embodiment.

### DETAILED DESCRIPTION

Referring generally to the FIGURES, described herein are methods of controlling a vehicle using an adaptive cruise control system (e.g., a cooperative adaptive cruise control system).

In many contexts, it may be necessary or desirable to autonomously (or semi-autonomously) control a vehicle. For example, it may be beneficial to autonomously (e.g., with limited or no user input, etc.) control the acceleration of a vehicle to automatically maintain a safe driving distance between vehicles (or other obstacles, etc.). In some embodiments, vehicles may communicate with one another (e.g., exchange information that is used to control the vehicle, etc.). For example, the vehicle may be a connected and automated vehicle (CAV) that may communicate with one or more vehicles (e.g., via vehicle-to-vehicle (V2V) communication, etc.) to maintain a safe and optimal inter-vehicle spacing (e.g., via a cooperative adaptive cruise control (CACC) system, etc.). In some contexts, the communication between vehicles may be compromised/altered (e.g., by an external system, etc.). For example, a false data injection (FDI) attack may compromise intervehicle communications and disrupt autonomous control of a vehicle (e.g., by injecting false data into an ACC system, etc.). In various embodiments, systems and methods of the present disclosure may facilitate robust autonomous (or semi-autonomous) control of a vehicle by detecting and/or estimating FDI attacks and using the detected/estimated FDI attacks to adjust ACC. For example, an electronic control unit may implement an actor-critic model to estimate FDI attacks and generate CACC commands to control the acceleration of a vehicle (e.g., to produce semi-global asymptotic stability).

Systems and methods of the present disclosure may offer one or more benefits such as: (i) increasing the robustness of a CACC system to external attack and/or disturbances (e.g., FDI attacks, etc.), (ii) reducing and/or eliminating the need for human intervention to maintain a desired inter-vehicle spacing, (iii) improving the stability of a cruise control system such as a cooperative adaptive cruise control system, (iv) increasing the safety and/or efficiency of a CACC system (e.g., by allowing vehicles to travel closer together, preventing error/attack-induced collisions, etc.), and/or (v) reducing a fuel consumption of a vehicle (e.g., by reducing and/or eliminating unneeded braking that may cascade through a platoon of autonomously controlled vehicles).

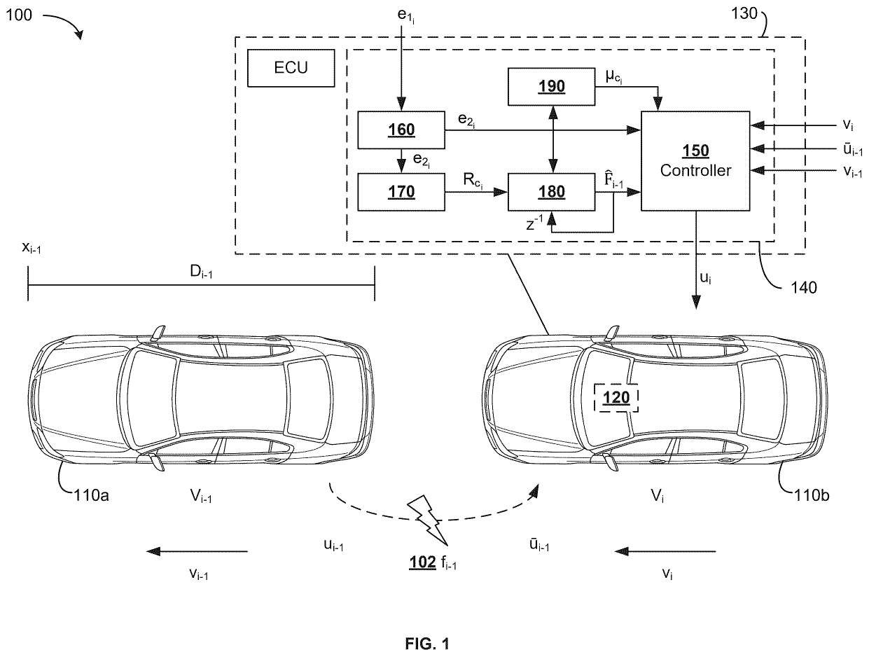

Referring now to FIG. 1, vehicle control system 100 is shown, according to an exemplary embodiment. Vehicle control system 100 may control one or more vehicles (shown as vehicle(s) 110). For example, vehicle control system 100 may receive information from a first vehicle (shown as first vehicle 110a) and use that information to control a second vehicle (shown as second vehicle 110b). In various embodiments, vehicle control system 100 is and/or includes a controller that is part of one or more of vehicle(s) 110.

As shown, vehicle(s) 110 (shown as Vᵢ, etc.) may be traveling in a convoy/platoon (e.g., one after another in proximity to one another, etc.) of n vehicles. For example, first vehicle 110a (shown as Vᵢ₋₁) may be a lead vehicle and second vehicle 110b (shown as Vᵢ) may be a follow vehicle. Each vehicle may have a position (shown as xᵢ, etc.), and a velocity (shown as vᵢ, etc.), a vehicle length (shown as Dᵢ, etc.). The following vehicle may be represented as:

$$\{ \begin{matrix}{\dot{x}}_{i} ( t ) = {υ}_{i} ( t ) \\ {\dot{υ}}_{i} ( t ) = - {b}_{i} {υ}_{i} ( t ) + {c}_{i} {u}_{i} ( t ) + {d}_{i} ( t )\end{matrix} ,$$

where bᵢ∈ [symbol] and cᵢ∈ [symbol] are constant parameters, xᵢε [symbol] is the position of the vehicle, vᵢ∈ [symbol] is the velocity of the vehicle, uᵢ∈ [symbol] is a control input (e.g., for a cooperative adaptive cruise control system, etc.), and dᵢ∈ [symbol] is an external disturbance. The lead vehicle may be represented as:

$$\{ \begin{matrix}{\dot{x}}_{i - 1} ( t ) = {υ}_{i - 1} ( t ) , \\ {\dot{υ}}_{i - 1} ( t ) = - {b}_{i - 1} {\dot{υ}}_{i - 1} ( t ) + {c}_{i - 1} ( t ) + {d}_{i - 1} ( t ) ,\end{matrix}$$

where xᵢ₋₁∈ [symbol] is the position of the vehicle, vᵢ₋₁∈ [symbol] is the velocity of the vehicle, uᵢ₋₁∈ [symbol] is a control input (e.g., for a cooperative adaptive cruise control system, etc.), and dᵢ₋₁∈ [symbol] is an external disturbance.

In some contexts, an FDI attack (shown as attack 102) is injected into the communications between vehicle(s) 110. In some embodiments, attack 102 may cause instability within the convoy/platoon. Systems and methods of the present disclosure may facilitate mitigating, reducing, and/or eliminating the impact of attack 102 on a convoy/platoon of vehicles using one or more cooperative adaptive cruise control systems. In various embodiments, the impact of attack 102 on the transmitted control signal is represented as:

$${\overline{u}}_{i - 1} ( t ) {=}^{Δ} \{ {u}_{i - 1} ( t ) - {f}_{i - 1} - ( t ) ,$$

where ūᵢ₋₁(t)∈ [symbol] is the corrupted transferred control signal from leader to follower and fᵢ₋₁(t)∈ [symbol] represents one or more FDI attacks. In various embodiments, the FDI attacks are bounded, unknown, and/or continuous. For example, the FDI attacks may be time-varying FDI attacks.

Vehicle control system 100 may facilitate following a vehicle with improved precision and/or responsiveness. For example, second vehicle 110b may include an adaptive cruise control system (e.g., a cooperative adaptive cruise control system) that receives information from first vehicle 110a and combines that information with other information (e.g., from sensor 120, etc.) to control the acceleration and/or velocity of second vehicle 110b. As used herein, acceleration may refer to negative acceleration (e.g., decreasing velocity), zero acceleration (e.g., no change in velocity), or positive acceleration (e.g., increasing velocity). For example, vehicle control system 100 may control the acceleration of one of vehicle(s) 110 to maintain a desired inter-vehicle spacing by causing the vehicle to maintain an existing velocity (e.g., substantially zero acceleration). As another example, vehicle control system 100 may control the acceleration of a follower vehicle to track the velocity of a leader vehicle (e.g., if the leader reduces velocity, vehicle control system 100 may reduce the velocity of the follower to maintain the desired inter-vehicle distance). In some embodiments, tracking the velocity of a leader vehicle may facilitate safe and efficient transportation.

One or more of vehicle(s) 110 may each include one or more electronic control units (shown as ECU(s) 130) and one or more sensors (shown as sensor 120). Additionally or alternatively, each of vehicle(s) 110 may include one or more additional/alternative components than those illustrated. For example, vehicle(s) 110 may include a transmission system (e.g., an antenna and a transmitter, a wireless communication system, etc.) for transmitting V2V communications, a propulsion system, a braking system, wheels, a GPS system, and/or the like.

Sensor 120 may be and/or include a sensor (or multiple sensors) for measuring the environment around the vehicle. For example, sensor 120 may be and/or include a radar, a laser, a camera, a range sensor, and/or the like. In various embodiments, sensor 120 is an on-board sensor. In some embodiments, sensor 120 uses sensor fusion to combine measurements from two or more sensors (e.g., combining LiDAR and camera data, etc.). In various embodiments, vehicle control system 100 (e.g., the CCS ECU, etc.) may use measurements/outputs from sensor 120 to perform the operations discussed herein. For example, the CCS ECU of second vehicle 110b may receive radar measurements from sensor 120, use the radar measurements to determine a speed and position of first vehicle 110a, and use the speed and position of first vehicle 110a to control second vehicle 110b (e.g., to maintain a desired inter-vehicle spacing, etc.). In various embodiments, sensor 120 measures a distance and relative velocity between the vehicle and another object (such as another vehicle). For example, a LiDAR positioned on second vehicle 110b may measure a distance between first vehicle 110a and second vehicle 110b and a relative velocity between first vehicle 110a and second vehicle 100b. It should be understood that while sensor 120 is shown in a particular location on second vehicle 110b, other positions/locations are possible, and the depicted location is meant only as an example.

Each ECU may be dedicated to a specific function or set of functions. Each ECU may be and/or include a computer system. In various embodiments, one or more of the ECUs include a processing circuit (not shown) having a processor and memory. In some embodiments, the processing circuit includes hardware for executing instructions, such as those making up a computer program. As an example and not by way of limitation, to execute instructions, a processor may retrieve/fetch instructions from an internal register, an internal cache, or a memory. The memory may include main memory for storing instructions for the processor to execute or data for the processor to operate on. In some embodiments, one or more memory management units (MMUs) are between the processor and the memory. In some embodiments, the memory includes random access memory (RAM). The memory may include mass storage for data or instructions. For example, the memory may include a removable disk drive, flash memory, an optical disc, a magneto-optical disc, magnetic tape, or a Universal Serial Bus (USB) drive. The memory may include removable or fixed media and may be internal or external to the ECUs. The memory may include any suitable form of non-volatile, solid-state memory or read-only memory (ROM). The memory may be and/or include a non-transitory computer-readable storage medium.

ECU(s) 130 may perform various operations associated with the vehicle. For example, ECU(s) 110 may include an adaptive cruise control system (ACCS) ECU (shown as ACCS 140) that may estimate FDI attacks in real time and control the vehicle to maintain an inter-vehicle spacing. FDI attacks may include an injection of false data into received information (e.g., false information injected into V2V communications of two or more vehicles, etc.). In various embodiments, ACCS 140 implements an actor-critic model that uses reinforcement learning and Lyapunov stability to estimate FDI attacks and control one or more vehicles to maintain a safe distance between lead and following vehicles (e.g., with asymptotic tracking of the desired distance, etc.). For example, ACCS 140 may implement continuous feedback using a robust integral of the sign of the error (RISE) within the actor-critic model to ensure a desired inter-vehicle distance while remaining resilient to FDI attacks and external disturbances. As another example, ACCS 140 may control a following vehicle while coordinating a string of vehicles.

ACCS 140 may include controller 150, first feedback system 160, critic 170, actor 180, and second feedback system 190. In various embodiments, ACCS 140 is a nonlinear Lyapunov-based controller. For example, actor 180 may be a controller and critic 170 may refine the learning process of actor 180. In various embodiments, second feedback system 190 provides a RISE signal that is used by critic 170 and/or actor 180 (e.g., to facilitate exponential error convergence, etc.). In various embodiments, actor 180 estimates FDI attacks.

Controller 150 may determine a weighted control signal based on a stability analysis:

$${U}_{i} ( t ) = − {Y}_{i} ( t ) − {\hat{F}}_{i − 1} ( t ) − {μ}_{{c}_{i}} ( t )$$

where \hat{F}ᵢ₋₁(t)∈ [symbol] is a weighted attack estimation, Uᵢ(t)≙cᵢuᵢ(t), and Yᵢ(t)∈ [symbol] is defined as:

$${Y}_{2} ( t ) {=}^{Δ} − {b}_{i} {v}_{i} ( t ) + {b}_{i − 1} {v}_{i − 1} ( t ) − {c}_{i − 1} {\overline{u}}_{i − 1} ( t ) + x {\text{?}}_{{d}_{i}} ( t ) + {α}_{1} {\dot{e}}_{{1}_{i}} ( t ) + {α}_{{2}_{i}} {e}_{{2}_{i}} ( t ) ,$$

$$\text{?} \text{indicates text missing or illegible when filed}$$

where α₁_{ᵢ}, α₂_{ᵢ}∈ [symbol] _{>0} is a user-defined gain, the filtered distance error (shown as e₂_{ᵢ}) is defined as shown below. μ_{c}_{ᵢ}(t)∈ [symbol] represents a RISE feedback term (e.g., generated by second feedback system 190) and may be determined according to:

$${μ}_{{c}_{i}} ( t ) {=}^{Δ} ( {K}_{i} + 1 ) {e}_{{2}_{i}} ( t ) + {v}_{i} ( t ) ,$$

where vᵢ(t)∈ [symbol] is a generalized solution to:

$${\dot{v}}_{i} ( t ) = ( {K}_{i} + 1 ) {α}_{{2}_{i}} {e}_{{2}_{i}} ( t ) + {θ}_{i} , sgn ( {e}_{{2}_{i}} ) ,$$

where Kᵢ∈ [symbol] and θ₁_{ᵢ}∈ [symbol] are positive constant control gains (e.g., that may be specified by a user), and sgn( ) is a vector signom function. In various embodiments, ACCS 140 (and/or another component) receives a control signal from a lead vehicle. For example, an ECU associated with second vehicle 110b may receive a real-time (e.g., continuous, etc.) control signal from first vehicle 110a (e.g., uᵢ₋₁) and an ECU associated with a third vehicle (not shown) that is following second vehicle 110b may receive a control signal from second vehicle 110b.

In various embodiments, ACCS 140 may model an estimated control signal of a lead vehicle as:

$${\hat{u}}_{i − 1} ( t ) {=}^{Δ} {\overline{u}}_{i − 1} ( t ) − {\hat{f}}_{i − 1} ( t ) ,$$

where \hat{f}ᵢ₋₁(t)∈ [symbol] is an estimated FDI attack (e.g., an estimate of attack 102). In some embodiments, ACCS 140 measures an accuracy of FDI attack estimation. For example, ACCS 140 may estimate an error for the FDI attacks as:

$$f {\text{?}}_{i − 1} {=}^{Δ} {f}_{i − 1} ( t ) − {\hat{f}}_{i − 1} ( t ) \text{?}$$

$$\text{?} \text{indicates text missing or illegible when filed}$$

ACCS 140 may represent weighted FDI attacks (introduced into uᵢ₋₁(t)) as a multilayer neural network:

$${F}_{i − 1} ( t ) = {W}_{i}^{T} σ ( {V}_{i}^{T} {δ}_{i} ) + {γ}_{i} ( {δ}_{i} ) ,$$

where δᵢ∈ [symbol] ^{2×1} represents inputs of the neural network, vectors Wᵢ∈ [symbol] ⁽ⁿ^{ₙ}^{+1)×1} represents constant, bounded, unknown ideal weights for an output layer of the neural network, Vᵢ∈ [symbol] ^{2×n}^{ₙ} represents constant, bounded, unknown ideal weights for a hidden layer of the neural network, nₙ represents a number of neurons in the hidden layer, σ(⋅)∈ [symbol] ⁽ⁿ^{ₙ}⁺¹⁾ represents the bounded activation functions vector, and γᵢ(⋅)∈ [symbol] represents the bounded function reconstruction error.

First feedback system 160 may receive a first distance error (shown as e₁_{ᵢ}) and generate a filtered distance error (shown as e₂_{ᵢ}). In various embodiments, the first distance error may be represented as:

$${e}_{{1}_{i}} ( t ) {=}^{Δ} {x}_{i} ( t ) − {x}_{i − 1} ( t ) + {D}_{i − 1} + {x}_{{d}_{i}} ( t ) ,$$

where Dᵢ₋₁∈ [symbol] is the length of the lead vehicle, and xa; E R is the desired safe distance between vehicles. First feedback system 160 may generate the filtered distance error as:

$${ϵ}_{{2}_{i}} ( t ) {=}^{Δ} {\dot{e}}_{{1}_{i}} ( t ) + {α}_{{1}_{i}} {e}_{{1}_{i}} ( t )$$

where α₁_{ᵢ}∈ [symbol] _{>0}, is a user-defined gain, ė₁_{ᵢ}(t)∈ [symbol] is a time derivative of the first distance error.

Critic 170 and actor 180 may be an actor-critic model. Critic 170 may be and/or include a neural network model (e.g., having an input layer, one or more hidden layers, and an output layer, etc.). Additionally or alternatively, actor 180 may be and/or include a neural network model. In various embodiments, critic 170 evaluates the performance of actor 180 to optimize actor 180. In various embodiments, critic 170 generates a reinforcement signal according to:

$${R}_{{c}_{i}} ( t ) {=}^{Δ} {W}_{{c}_{i}}^{T} σ ( {V}_{{c}_{i}}^{T} {e}_{{2}_{i}} ) + {λ}_{{c}_{i}}$$

where σ(⋅)∈ [symbol] ⁽ⁿ^{_{c}}⁺¹⁾ is a nonlinear activation function, e₂_{ᵢ}(t) is an input to critic 170, and λ_{c}_{ᵢ}∈ [symbol] is an auxiliary term determined from stability analysis according to:

$${\dot{λ}}_{{c}_{i}} = {\hat{W}}_{{c}_{i}}^{T} {σ}^{′} ( {\hat{V}}_{{c}_{i}}^{T} {e}_{{2}_{i}} ) {\hat{V}}_{{c}_{i}}^{T} ( {μ}_{{c}_{i}} + {α}_{{2}_{i}} {e}_{{2}_{i}} ) − {K}_{{c}_{i}} {R}_{{c}_{i}} − {θ}_{{2}_{i}} sgn ( {R}_{{c}_{i}} )$$

where K_{c}_{ᵢ}∈ [symbol] and θ₂_{ᵢ}∈ [symbol] are constant positive gains. In various embodiments, the updating laws for critic 170 are based on:

$$\{ \begin{matrix}{\dot{\hat{W}}}_{{c}_{i}} = proj ( − {ψ}_{{w}_{c}} σ ( {\hat{V}}_{{c}_{i}}^{T} {e}_{{2}_{i}} ) {R}_{{c}_{i}} − {ψ}_{{w}_{c}} W {\text{?}}_{{c}_{i}} ) , \\ {\dot{\hat{V}}}_{{c}_{i}} = proj ( − {ψ}_{{v}_{c}} {e}_{{2}_{i}} {\hat{W}}_{{c}_{i}}^{T} {σ}^{′} ( {\hat{V}}_{{c}_{i}}^{T} {e}_{{2}_{i}} ) {R}_{{c}_{i}} − {ψ}_{{v}_{c}} {\hat{V}}_{{c}_{i}} )\end{matrix}$$

$$\text{?} \text{indicates text missing or illegible when filed}$$

where Ψ_{w}_{_{c}} and ψᵥ_{_{c}}∈ [symbol] are positive control gains.

In various embodiments, actor 180 approximates Fᵢ₋₁(t) (e.g., the weighted FDI attacks) as:

$${\hat{F}}_{i - 1} ( t ) {=}^{Δ} {\hat{W}}_{i}^{T} σ ( {\hat{V}}_{i}^{T} {δ}_{i} )$$

where δᵢ may be represented as:

$${δ}_{i} {=}^{Δ} {[ 1 , {ϕ}_{i}^{T} ]}^{T}$$

where φᵢ≙\hat{F}ᵢ₋₁(t), Ŵᵢ∈ [symbol] ⁽ⁿ^{ₙ}^{+1)×1} and \hat{V}ᵢ∈ [symbol] ^{2×n}^{ₙ} represent the estimated ideal weights. In various embodiments, actor 180 is a multilayer neural network. In some embodiments, the updating laws for the estimated ideal weights are determined from stability analysis as:

$$\{ \begin{matrix}{\dot{\hat{W}}}_{i} = {ϕ}_{{e}_{{2}_{i}}}^{w} + {ϕ}_{{R}_{{c}_{i}}}^{w} , \\ {\dot{\hat{V}}}_{i} = {ϕ}_{{e}_{{2}_{i}}}^{v} + {ϕ}_{{R}_{{c}_{i}}}^{v} ,\end{matrix}$$

$$where$$

$$\{ \begin{matrix}{ϕ}_{{e}_{{2}_{i}}}^{w} {=}^{Δ} proj ( {ψ}_{{w}_{i}} {α}_{{2}_{i}} σ ( {\hat{V}}_{i}^{T} {δ}_{i} ) {\hat{V}}_{i}^{T} {δ}_{i} {e}_{{2}_{i}} ) , \\ {ϕ}_{{R}_{{c}_{i}}}^{v} {=}^{Δ} proj ( {ψ}_{{w}_{i}} σ ( {\hat{V}}_{i}^{T} {δ}_{i} ) {R}_{{c}_{i}} {\hat{W}}_{{c}_{i}}^{T} {σ}^{′} ( {\hat{V}}_{{c}_{i}}^{T} {e}_{{2}_{i}} ) {\hat{V}}_{{c}_{i}}^{T} ) , \\ {ϕ}_{{e}_{{2}_{i}}}^{v} {=}^{Δ} proj ( {ψ}_{{v}_{i}} {α}_{{2}_{i}} {δ}_{i} \text{?} {e}_{{2}_{i}} {\hat{W}}_{{c}_{i}}^{T} {σ}^{′} ( {\hat{V}}_{i}^{T} {δ}_{i} ) ) , \\ {ϕ}_{{R}_{{c}_{i}}}^{v} {=}^{Δ} proj ( {ψ}_{{v}_{i}} {δ}_{i} {R}_{{c}_{i}} {\hat{W}}_{{c}_{i}}^{T} {σ}^{′} ( {\hat{V}}_{{c}_{i}}^{T} {e}_{{2}_{i}} ) {\hat{V}}_{{c}_{i}}^{T} {\hat{W}}_{i}^{T} {σ}^{′} ( {\hat{V}}_{i}^{T} {δ}_{i} ) )\end{matrix}$$

$$where$$

$${σ}^{′} ( {\hat{V}}_{i}^{T} {δ}_{i} ) ≡ \frac{d σ ( {V}_{i}^{T} {δ}_{i} )}{d ( {V}_{i}^{T} {δ}_{i} )} {\vert}_{{V}_{i}^{T} {δ}_{i} = {\hat{V}}_{i}^{T} {δ}_{i}} ,$$

$$\text{?} \text{indicates text missing or illegible when filed}$$

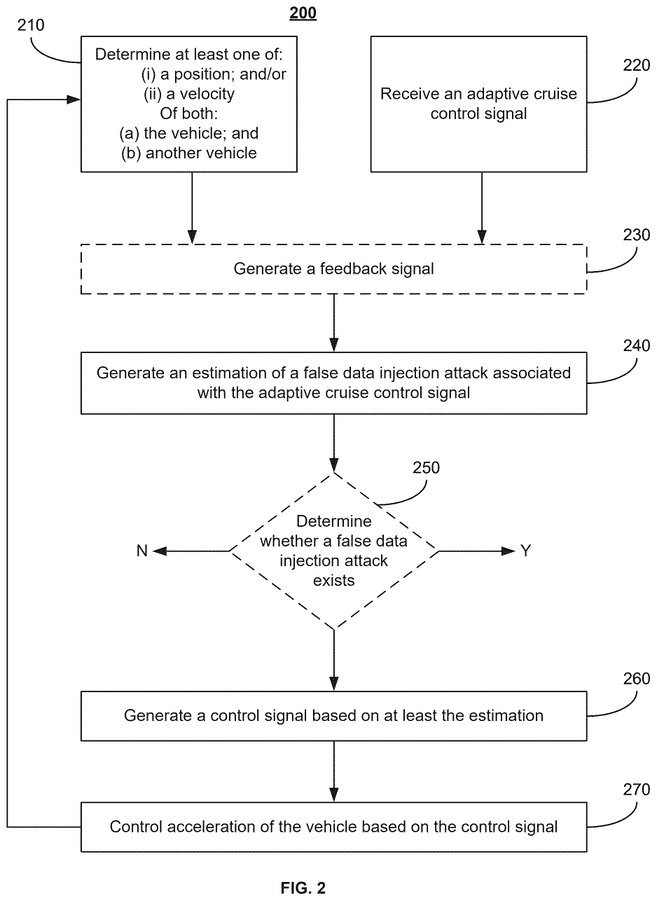

the matrices ψ_{w}_{ᵢ}∈ [symbol] ⁽ⁿ^{ₙ}^{+1)×(n}^{ₙ}⁺¹⁾ and ψᵥ_{ᵢ}∈ [symbol] 2×2 may be constant, positive definite, and/or symmetric gain matrices, R_{c}_{ᵢ}∈ [symbol] represents a reinforcement signal, the operator proj( ) is a smooth projection operator (e.g., which may ensure that the estimated weights Ŵᵢ and \hat{V}ᵢ remain bounded, etc.), Ŵ_{c}_{ᵢ}∈ [symbol] ⁽ⁿ^{_{c}}^{+1)×1} and \hat{V}_{c}_{ᵢ}∈ [symbol] ^{1×n}^{_{c}} may represent the estimated weights introduced for the critic neural network, and n_{c} is the number of neurons in the hidden layer of the critic neural network. Operation of ACCS 140 is described in greater detail with reference to FIG. 2 below.

Referring now to FIG. 2, method 200 of controlling a vehicle is shown, according to an exemplary embodiment. In various embodiments, ACCS 140 implements method 200. For example, ACCS 140 may implement method 200 to control a vehicle (e.g., second vehicle 110b, etc.) to maintain a desired inter-vehicle spacing while preventing disruptions due to injected data attacks. At step 210, method 200 may include determining at least one of (i) a position and/or (ii) a velocity of both (a) the vehicle and (b) another vehicle. For example, method 200 may include measuring a position and velocity of a lead vehicle (e.g., xᵢ₋₁, vᵢ₋₁, etc.) using sensor 120 and determining a position and/or velocity (e.g., xᵢ, vᵢ, etc.) of a follow vehicle (e.g., using a global-positioning system, etc.). Additionally or alternatively, at step 220, method 200 may include receiving an adaptive cruise control signal. For example, method 200 may include receiving an adaptive cruise control signal (e.g., uᵢ₋₁, ūᵢ₋₁, etc.) from one or more lead vehicles. As another example, a follower may receive the control signal from the lead vehicle via wireless communication. In various embodiments, the adaptive cruise control signal (e.g., received from the leader) is a control signal that may be corrupted under FDI attacks (e.g., the control signal is not the adaptive cruise control itself but may be used by the adaptive cruise control system). In some embodiments, the adaptive cruise control signal is modified (e.g., corrupted due to an injection attack, etc.). For example, step 220 may include receiving an original adaptive cruise control signal transmitted from a lead vehicle, an attack signal transmitted from an external (e.g., third-party) source, and/or a combined signal (e.g., a combination of the original adaptive cruise control signal and the attack signal, etc.).

At step 230, method 200 may include generating a feedback signal. For example, step 230 may include generating the first distance error e₁_{ᵢ} (e.g., using first feedback system 160, etc.) and/or generating the filtered distance error e₂_{ᵢ} (e.g., using second feedback system 190, etc.). In some embodiments, step 230 includes first generating the first distance error and then generating the filtered distance error based on the first distance error. In some embodiments, step 230 is omitted.

At step 240, method 200 may include generating an estimation of a false data injection attack associated with the adaptive cruise control signal. For example, step 240 may include generating \hat{F}ᵢ₋₁(t) as described above. In various embodiments, critic 170 and/or actor 180 generate the estimation. For example, critic 170 and actor 180 may collaboratively generate the estimation (e.g., via actor 180 generating the estimation and critic 170 updating actor 180, etc.). In various embodiments, the estimation estimates an FDI attack (e.g., if present).

At step 250, method 200 may include determining whether a false data injection attack exists. For example, step 250 may include comparing the estimation to a threshold to determine whether the estimation exceeds the threshold. If an attack exists (Y), method 200 may include performing one or more first actions (e.g., transmitting an alert, taking corrective action, alerting a user, etc.). If an attack does not exist (N), method 200 may include performing one or more second actions (e.g., operating normally, etc.). In either case, method 200 may continue at step 260.

At step 260, method 200 may include generating a control signal based on at least the estimation. For example, step 260 may include generating uᵢ(t) as described above. In various embodiments, controller 150 generates the control signal (e.g., based on one or more of the estimation \hat{F}ᵢ₋₁(t), the filtered distance error e₂_{ᵢ}, the position of the lead vehicle xᵢ₋₁, the velocity of the lead vehicle vᵢ₋₁, the position of the vehicle xᵢ, the velocity of the vehicle vᵢ, the feedback μ_{c}_{ᵢ}(t), and/or the adaptive cruise control signal (e.g., a control signal) from the lead vehicle—e.g., where uᵢ₋₁ is the original signal, and ūᵢ₋₁ is the corrupted/altered signal.

At step 270, method 200 may include controlling acceleration of the vehicle based on the control signal. For example, step 270 may include increasing a velocity of the vehicle, decreasing a velocity of the vehicle, or maintaining a velocity of the vehicle. In various embodiments, step 270 includes operating a throttle and/or brake of the vehicle. In some embodiments, the acceleration is controlled via software. In various embodiments, controller 150 performs step 270.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

What is claimed is:

1. A method for controlling a vehicle, comprising:
receiving, from an external source, an adaptive cruise control signal;
generating, using an actor-critic reinforcement learning model, an estimation of a false data injection attack associated with the adaptive cruise control signal;
generating, based on (i) the estimation, (ii) an error describing a difference between (a) an actual distance between the vehicle and another vehicle and (b) a desired distance between the vehicle and the another vehicle, and (iii) a velocity of the vehicle and the another vehicle, a control signal; and
controlling acceleration of the vehicle based on the control signal.

2. The method of claim 1, further comprising generating a feedback signal based on an integral of a sign of the error, and wherein generating the control signal is further based on the feedback signal.

3. The method of claim 2, wherein the actor-critic reinforcement learning model comprises an actor implemented as a first neural network and a critic implemented as a second neural network.

4. The method of claim 3, wherein the first neural network and the second neural network receive the feedback signal as an input.

5. The method of claim 4, wherein generating the estimation comprises:
generating, using the first neural network, a reinforcement signal based on (i) the feedback signal and (ii) the error;
updating the second neural network using the reinforcement signal; and
generating the control signal using the updated second neural network.

6. The method of claim 5, further comprising measuring, using a radar, the actual distance between the vehicle and the another vehicle.

7. The method of claim 1, wherein controlling acceleration of the vehicle includes controlling at least one of (i) a brake of the vehicle and/or (ii) a throttle of the vehicle.

8. A cooperative adaptive cruise control (CACC) system for a vehicle, comprising:
a processing circuit comprising a processor and memory, the memory having instructions stored thereon that, when executed by the processor, cause the processor to:
receive a signal, wherein the signal is transmitted from a wireless transmitter that is not positioned on the vehicle;
generate, using an actor-critic reinforcement learning model, an estimation of a false data injection attack associated with the signal;
generate, based on (i) the estimation, (ii) an error describing a difference between (a) an actual distance between the vehicle and another vehicle and (b) a desired distance between the vehicle and the another vehicle, and (iii) a velocity of the vehicle and the another vehicle, a control signal; and
control acceleration of the vehicle based on the control signal.

9. The CACC system of claim 8, wherein the instructions further cause the processor to generate a feedback signal based on an integral of a sign of the error, and wherein generating the control signal is further based on the feedback signal.

10. The CACC system of claim 9, wherein the actor-critic reinforcement learning model comprises an actor implemented as a first neural network and a critic implemented as a second neural network.

11. The CACC system of claim 10, wherein the first neural network and the second neural network receive the feedback signal as an input.

12. The CACC system of claim 11, wherein generating the estimation comprises:
generating, using the first neural network, a reinforcement signal based on (i) the feedback signal and (ii) the error;
updating the second neural network using the reinforcement signal; and
generating the control signal using the updated second neural network.

13. The CACC system of claim 12, further comprising a radar, and wherein the instructions further cause the processor to determine the actual distance between the vehicle and the another vehicle based on at least one measurement from the radar.

14. The CACC system of claim 8, wherein controlling acceleration of the vehicle includes controlling at least one of (i) a brake of the vehicle and/or (ii) a throttle of the vehicle.

15. A vehicle, comprising:
an antenna configured to receive at least a signal transmitted from a wireless transmitter that is not positioned on the vehicle;
a throttle;
a brake; and
an adaptive cruise control system configured to:
determine an error describing a difference between (a) an actual distance between the vehicle and another vehicle and (b) a desired distance between the vehicle and the another vehicle;
generate, using an actor-critic reinforcement learning model based on the error, an estimation of a false data injection attack associated with the signal;
generate, based on (i) the estimation, (ii) the error, and (iii) a velocity of the vehicle and the another vehicle, a control signal; and
operate at least one of the throttle and/or the brake based on the control signal.

16. The vehicle of claim 15, wherein the adaptive cruise control system is further configured to generate a feedback signal based on an integral of a sign of the error, and wherein generating the control signal is further based on the feedback signal.

17. The vehicle of claim 16, wherein the actor-critic reinforcement learning model comprises an actor implemented as a first neural network and a critic implemented as a second neural network.

18. The vehicle of claim 17, wherein the first neural network and the second neural network receive the feedback signal as an input.

19. The vehicle of claim 18, wherein generating the estimation comprises:
generating, using the first neural network, a reinforcement signal based on (i) the feedback signal and (ii) the error;
updating the second neural network using the reinforcement signal; and
generating the control signal using the updated second neural network.

20. The vehicle of claim 15, further comprising a radar, and wherein the adaptive cruise control system is further configured to measure the actual distance between the vehicle and the another vehicle using the radar.
